(19) United States
(12) Patent Application Publication
(10) Pub. No.: US 2002/0112193 A1
(43) Pub. Date: Aug. 15, 2002

(54) Power control of a processor using hardware structures controlled by a compiler with an accumulated instruction profile

(75) Inventors: Erik R. Altman, Danbury, CT (US); Clair John Glossner III, Carmel, NY (US); Erdem Hokenek, Yorktown Heights, NY (US); David Meltzer, Wappingers Falls, NY (US); Mayan Moudgill, White Plains, NY (US)

Correspondence Address: F. CHAU & ASSOCIATES, LLP, Suite 501, 1900 Hempstead Turnpike, East Meadow, NY, 11554, US

(73) Assignee: International Business Machines Corporation, Armonk, NY

(21) Appl. No.: 09/780,634

(22) Filed: Feb. 9, 2001

(51) Int. Cl. G06F 1/26; G06F 1/28; G06F 1/30

(52) U.S. Cl. 713/323

(57) ABSTRACT

A microprocessor includes a logic circuit. A selection device is coupled to the logic circuit, and the selection device provides switching of on/off states of the logic circuit based on a stored logical value. A program instruction is included which sets the stored logical value to control the on/off states of the logic circuit based on anticipated usage of the logical circuit in accordance with an instruction sequence of the microprocessor.

### BACKGROUND OF THE INVENTION

1. Field of the Invention

The present invention relates to power control of a microprocessor digital integrated circuit and more particularly to an apparatus and method for dynamic power control of portions of a processor by embedding power control information in the instructions generated by a compiler.

2. Description of the Related Art

Dynamic power control of processors may be divided into two general categories, cycle by cycle control using clock gating techniques and longer term control based on software settings of power saving modes. Clock gating relies on logic circuits to analyze whether a function is to be used during the current clock cycle and if not, degating the clock to the portion of the logic used by the function. This process expends power in the analysis logic to save power in the clocked logic. Furthermore, since the logic which is clocked is active, only the dynamic component of the power dissipation is eliminated for the cycle in which the clock is degated. It would also be desirable to eliminate the leakage or static component as well. Power saving modes are used for longer term power saving but require more overhead to invoke the mode and resume normal operation.

U.S. Pat. No. 4,980,836, APPARATUS FOR REDUCING COMPUTER SYSTEM POWER CONSUMPTION, teaches a general method of software controlled power saving modes in which each individual processor and I/O controller is provided with a power down mode and the operating system dynamically monitors usage of each unit and shuts down units when the units are found to be unused. The power down mode is conventionally implemented by controlling a regulator generating the power supply voltage, thus eliminating both the active and static components of the power dissipation. This global mode approach of the current art suffers from several weaknesses. The approach requires that the operating system monitor activity, at some cost of power, the approach cannot predict future activity. A unit may be turned on and off many times so that actual power savings are small.

U.S. Pat. No. 5,781,062, SEMICONDUCTOR INTEGRATED CIRCUIT, teaches that logic having the multi-threshold complementary metal oxide semiconductor (MTCMOS) structures which generate a virtual Vdd and ground may include a header/footer switch structure controlled by a global power saving signal, e.g., “Standby Control Signal”. Two modes of power saving control are taught in U.S. Pat. No. 5,781,062. In the first mode, during the standby period, the header/footer switch devices periodically repeat conduction/non-conduction to provide leakage power to the virtual Vdd and ground to prevent loss of information in the logic. In the second mode, no periodic conduction interval is provided during the standby period, thereby increasing the power savings by eliminating leakage power at the expense of discharging the virtual Vdd line, which must be charged back to Vdd at the start to the active period. The turning off the virtual Vdd and ground in this manner only saves more power than cycle by cycle clock gating if invoked for many cycles. This art teaches no means to determine that the portion of logic turned off will not be used for many cycles in the future so an explicitly programmed global mode is the only means available in the prior art to control the header/footer switches.

Power dissipation in CMOS logic includes two components: active power, expended when the circuits are switching and static or leakage power which is expended whenever Vdd and ground are applied to the logic. Conventional power control of active power relies on clock gating to turn off the clock on a cycle by cycle basis when the logic is not used.

Referring to FIG. 1, a MTCMOS structure used to control the leakage power of static CMOS logic 12 is shown. When the SLEEP signal is active, the Vdd and Ground are disconnected from the rest of the logic by transistors 11 and 13 and thus no leakage power is expended. Conventionally, the threshold of the SLEEP mode field effect transistors (FETs) 11 and 13 is made higher than the rest of the logic FETs to ensure minimal leakage power. There are two disadvantages to this technique: the first is that the sizing of the sleep mode FETs is critical to not compromise performance, and the second is that when Vdd or ground are disconnected, the logic gradually loses stored charge and thus all memory of the previously stored state. When power is restored, all the discharged nodes of the logic must be recharged, consuming power. Therefore, the SLEEP mode control must be invoked for several cycles to achieve real power savings.

Because it is difficult to predict when logic of a processor will be used in the future, the prior art relies on an operating system global control to control the SLEEP mode of the MTCMOS structure. Referring to FIG. 2, a processor 22 is shown with such a control structure. Processor 22 is powered by a virtual Vdd and virtual Ground controlled by FETs 21 and 23 using a control signal SLEEP generated from the state of a Sleep mode latch 24 (which is always powered). This latch 24 is set by processor 22 via a Set signal 25, asserted by the processor via a programmed operation when no work remains to be done. An operating system kernel must save the state of processor 22 needed to resume operation in some nonvolatile storage (not shown) prior to asserting signal 25. Some external event 26 is connected to the Reset of the sleep mode latch 24 to resume operation. Conceptually this is identical to a “Suspend” mode with a power regulator shutoff used in some computers.

Therefore, a need exists for an apparatus and method which more efficiently control power in digital integrated circuits. A further need exists for power control of processors based on knowledge of future use of particular hardware structures.

### SUMMARY OF THE INVENTION

A microprocessor includes a logic circuit. A selection device is coupled to the logic circuit, and the selection device provides switching of on/off states of the logic circuit based on a stored logical value. A program instruction is included which sets the stored logical value to control the on/off states of the logic circuit based on anticipated usage of the logical circuit in accordance with an instruction sequence of the microprocessor.

In other embodiments, the selection device may include a switch which provides a connection from a supply voltage to a power line of the at least one logic circuit in an on state. The selection device may include a switch which provides a connection from ground to a power line of the at least one logic circuit in an on state. The microprocessor may include a register coupled to the selection device to store the stored logic value. The register is updated after a number of instruction cycles. An input table may include an instruction sequence and associated resource needs for the logical unit wherein the anticipated usage is determined in accordance with the input table.

In still other embodiments, the anticipated usage of the logical unit may include usage of the logical device after a number of instruction cycles. The microprocessor may include an output table with logical states corresponding to power-saving on/off states of the logical device and the program instruction may set the stored logical value to control the logic circuit in accordance with the power-saving on/off states.

Another microprocessor of the present invention includes a plurality of logic circuits divided into functional groups. A selection device is coupled to each of the functional groups, and each selection device provides switching of on/off states of the corresponding functional group based on logical values stored in a register. A program instruction sets the logical values in the register to control the on/off states of the functional groups. A compiler program generates the logical values to be set in the register based on instruction sequences which anticipate usage of each of the functional groups.

The selection devices may each include a switch which provides a connection from a supply voltage to a power line of the functional group in an on state or a switch which provides a connection from ground to a power line of the functional group in an on state. The register may include one memory location for each functional group. The register is preferably updated after a number of instruction cycles. The microprocessor may include an input table generated by the compiler program and may include an instruction sequence and associated resource needs for the each of the functional groups wherein the usage of the functional groups is determined in accordance with the input table. The usage of the functional groups may include usage of the functional groups after a number of instruction cycles. The microprocessor may include an output table including logical states corresponding to power-saving on/off states of the functional groups.

A method for generating embedded instruction sequences to control power to logic circuits in a microprocessor, in accordance with the present invention, generates an instruction sequence which controls a functional program for the microprocessor. The instruction sequence is analyzed to determine which of the logic circuits are active on each instruction cycle, and a number of instruction cycles for which each logic circuit will be inactive after a current instruction cycle is compared to a value for each instruction cycle of the functional program. Instruction sequences are inserted to turn each of the logical circuits on or off based on the comparison.

In other methods, inserting instruction sequences may include programming a register with logical values wherein each of the logical circuits is turned on or off based on the logical values. The value of the comparison may include a number determined to provide net power savings in the logical circuits. A program storage device readable by machine, tangibly embodying a program of instructions executable by the machine may be included to perform the methods recited herein.

These and other objects, features and advantages of the present invention will become apparent from the following detailed description of illustrative embodiments thereof, which is to be read in connection with the accompanying drawings.

### BRIEF DESCRIPTION OF DRAWINGS

The invention will be described in detail in the following description of preferred embodiments with reference to the following figures wherein:

FIG. 1 is a schematic diagram of a multi-threshold CMOS (MTCMOS) structure for power down of a logic function in accordance with the prior art;

FIG. 2 is a schematic diagram of a prior art processor structure with an MTCMOS structure with global sleep mode control;

FIG. 3 is a schematic diagram of a processor constructed in accordance with one embodiment of the present invention which is divided into several independently controlled portions of logic, each portion having individual MTCMOS control;

FIG. 4 is a schematic diagram of a table constructed during an analysis part of code generation of a compiler for the processor of FIG. 3 in accordance with the present invention;

FIG. 5 is a block/flow diagram of a system/method for a code generation part of a compiler to generate switch controls for the processor of FIG. 3 in accordance with the present invention;

FIG. 6 is an instruction sequence resulting from the insertion of power map control instructions for the example of FIG. 4 in accordance with the present invention.

### DESCRIPTION OF PREFERRED EMBODIMENTS

The present invention provides control to header/footer devices of a microprocessor, preferably a digital integrated circuit using multi-threshold complementary metal oxide semiconductor (MTCMOS) structures, although other field effect transistor devices or other types of structures may be employed. Based on knowledge that the controlled logic will not be used for some cycles in the future, selected header/footer devices are switched off. Knowledge of the need for particular device may be extracted from a memory device, a lookout table or instruction sequences from a compiler. This knowledge of the need for a particular device(s) is then employed to switch on or off the header/footer switches. These switches may include CMOS FETs or any other switching device.

In one embodiment, the knowledge of device use can be extracted by a compiler when the instructions for the processor are generated and associated with the text of the instructions for use during their execution. In a particularly useful embodiment, a method is employed for subdividing the logic devices/circuitry of the microprocessor into a plurality of power control regions, which can be separately controlled, e.g., by their own header/footer switches. Instructions can be generated to separately control power to the plurality of control regions.

One aspect of the present invention provides a microprocessor digital integrated circuit divided into a plurality of independent groups of logic, each with, for example, an MTCMOS structure with an independent control of the header/footer switches, and instructions in the instruction set architecture of the microprocessor which permit program control of the state of the switches. The instruction sequences which form the program for the microprocessor may be generated by a compiler program to which are specified the divisions of the logic by function and the minimum time for which the header/footer should be open to achieve power savings. The compiler preferably includes program logic that determines whether the resources associated with any of these functions will not be used for a minimum time interval associated with that function. A code generation phase is provided in the program logic which inserts instructions needed to turn off each group when the group will not be used. Program logic is added to the compiler and run time environment to save and restore any state which will be lost by the turning off of the virtual Vdd and ground. Use of the present invention will result in power savings greater than individual clock gating and provide these savings without the negative system effects associated with invoking a global sleep mode.

It should be understood that the elements shown in the FIGS. may be implemented in various forms of hardware, software or combinations thereof. Preferably, these elements are implemented in a combination of hardware and software, and may be hardwired or stored and executed on one or more appropriately programmed general purpose digital computers having a processor and memory and input/output interfaces. Referring now to the drawings in which like numerals represent the same or similar elements and initially to FIG. 3, a schematic diagram of an illustrative circuit 100 is shown to illustratively describe the present invention; however the present invention is broader and is applicable to other circuits, integrated circuits or semiconductor chips, as well.

In one embodiment of the present invention, a processor 100 includes logic circuits 112, 121 and 123. Functional groups of logic circuits are further subdivided into groups 101-107, associated with particular instructions and header and footer FETs 108, preferably MTCMOS, with individual control (lines 110) are provided for each logical group 101-107 (lines 110 for groups 102-106 are omitted for simplicity). Processor 100 is constructed according to the present invention with the processor logic divided into a group of logic circuits 112 without individually controlled header/footer switches. This group 112 (or groups) of logic circuits do not include an individual MTCMOS header/footer control for the entire group although portions of group 112 or the entire circuit of group 112 may include individual header/footer controls in other embodiments. Seven individually controlled groups 101-107 corresponding to the execution resources of particular instruction types are provided with individually controllable header/footer switches 108.

Some of the logic (112) not having such control could actually be subdivided and some subdivisions provided with power controls, however, the divisions shown in FIG. 3 are sufficient to show the principles of the invention. It is to be understood the that present invention may be applied to many different logic arrangements and that the divisions of such logic circuits can be made according to criteria defined by, for example, a chip designer using common sense principles to determine workable and efficient subdivisions of the circuit.

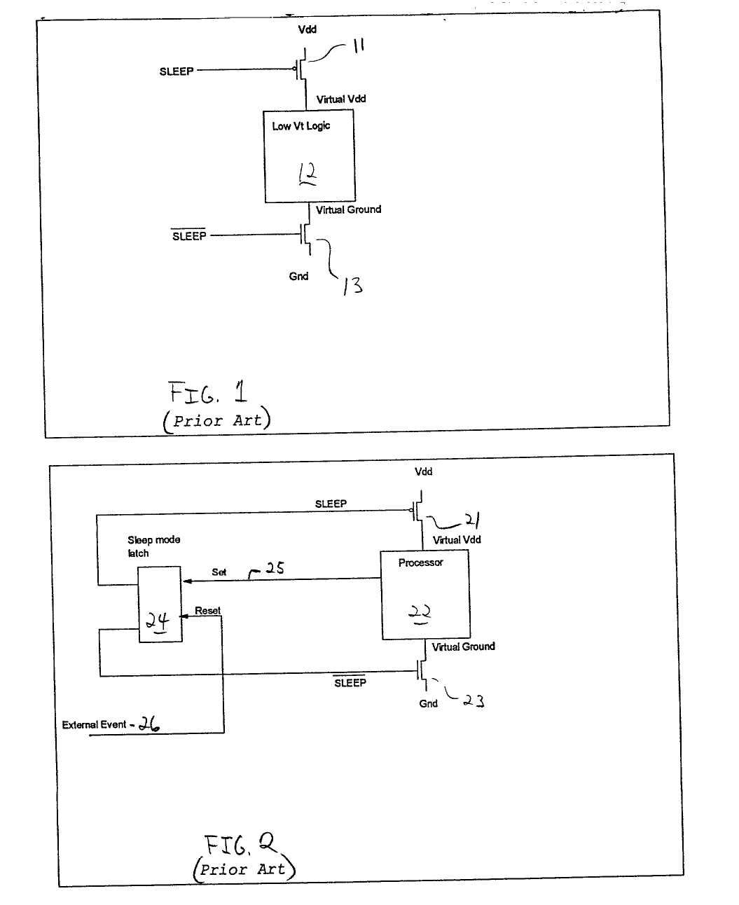

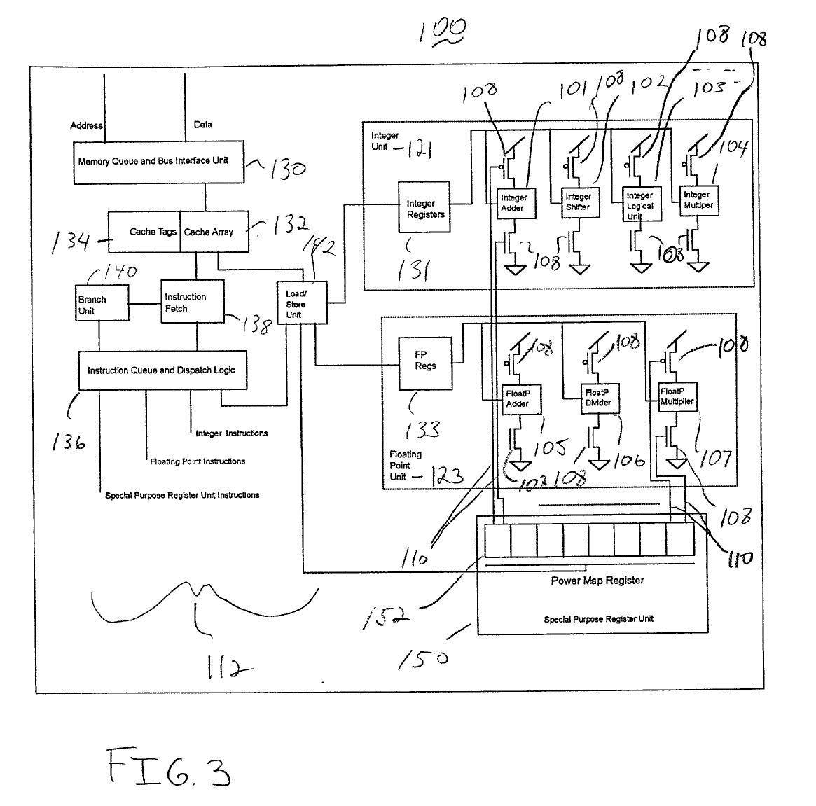

In one embodiment, all logic associated with a current state of processor 100, included in registers 131, 133 and other registers (not shown) within logic 112 is not powered by a virtual Vdd/ground and instead remains “on”. Alternately, this logic may be powered by a virtual Vdd/ground controlled by a global signal as described above. However, since the current processor state cannot be lost, this virtual vdd/ground cannot be disconnected from real Vdd/ground unless the processor state has been saved in some nonvolatile storage. A nonvolatile storage and operating system support are needed for a state save and restore with a global power saving mode as described above with reference to FIG. 2. Since this overall power control alternative is known, it is not shown in FIG. 3.

Processor 100 may include a plurality of different devices. As illustratively shown in FIG. 3, an integer unit 121 includes integer logic, such as for example, adder logic 101, integer shifter logic 102, integer logical unit 103 and integer multiplier logic 104, along with integer registers 131. A floating point unit 123 includes floating point logic, such as for example, floating point adder logic 105, floating point divider logic 106, and floating point multiplier logic 107, along with floating point registers 133.

Group 112 includes a memory queue and bus interface unit 130 which receives address information and data as inputs, data is stored in the addressed locations in a cache array 132. Cache tags 134 may be applied to data stored in the cache array 132 to identify the information present in cache array 132. An instruction queue and dispatch logic unit 136 receives instructions (e.g., special purpose unit instructions, floating point instructions and/or integer instructions) and directs them to the appropriate execution resources for processing (e.g., special purpose register unit 150, floating point unit 123, integer unit 121). An instruction fetch unit 138 fetches the next instruction to be executed from either the next sequential instruction address or the branch target address. A branch unit 140 is presented any branch instructions fetched by instruction fetch unit 138 and determines if the next instruction to by executed after the branch is the next sequential instruction or the instruction at a taken branch target fetched from an address calculated from information specified by the branch instruction. A load/store unit 142 executes all load and store instructions and provides the data transfer interface between the cache array 132 and integer registers 131, floating point registers 133 and special purpose registers in the special purpose register unit 150, e.g., register 152.

In accordance with the present invention, control for each of the logic groups 101-107 is provided by a bit in a special purpose unit 150 including a power map register 152. The values in register 152 are set by a special immediate instruction which loads a value from an instruction text into register 152. These instructions are inserted by a code generator of a compiler described as follows.

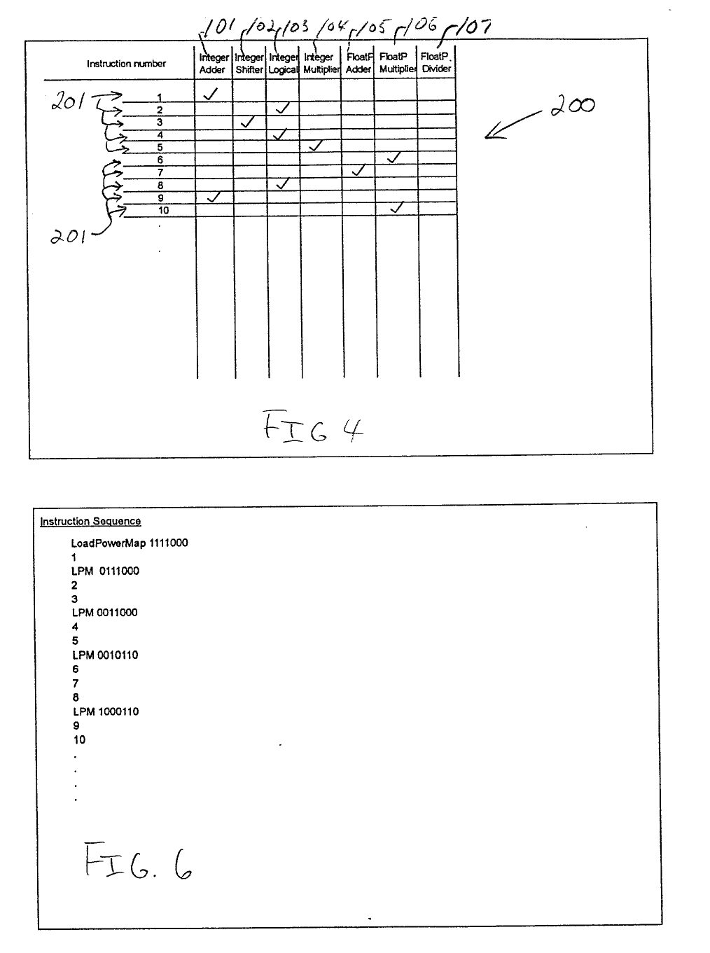

Referring to FIG. 4, during the end of the code assignment phase of compilation, a compiler constructs a table 200 with the information illustratively shown in FIG. 4. Each column of table 200 corresponds to a group of logic (groups labeled 101-107 in FIG. 3) with individually controlled header/footer FETs 108 (FIG. 3), and each of rows 201 corresponds to an instruction labeled 1-10 in execution order. A check mark is placed in a cell of table 200 to represent when that resource (e.g., logic groups) is used by the instruction of the corresponding row. The longer the distance in each column between check marks, the longer a logical group (101-107) may be powered off. In a preferred embodiment, the compiler preferably reorders the code to maximize the distance between check marks in each column consistent with the optimization directives of the compiler.

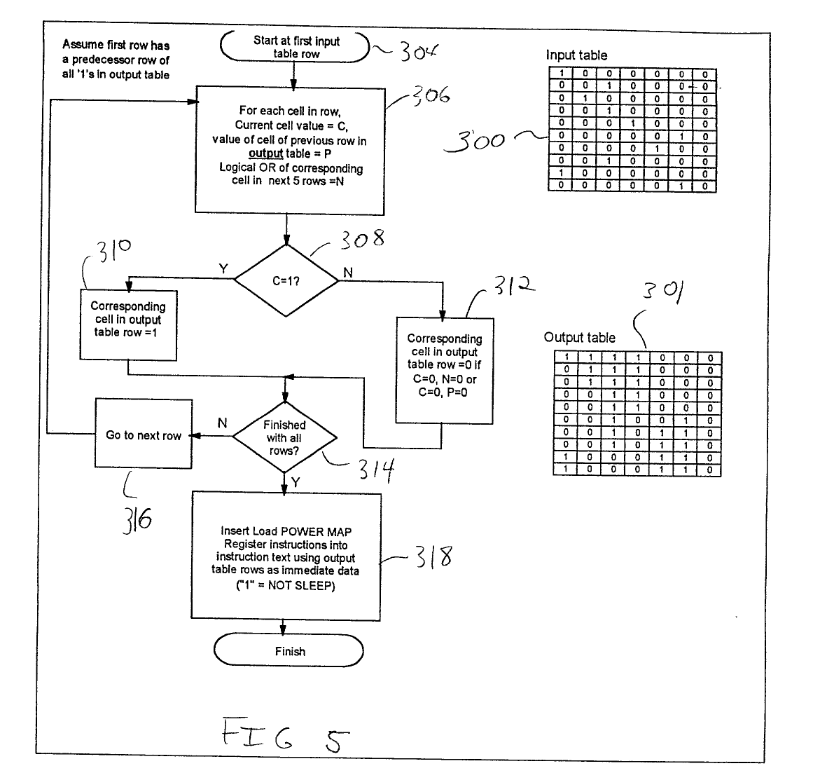

Once table 200 is filled-in, the method shown in FIG. 5 is run to generate “Load Power Map Register” instructions with the appropriate immediate data values. The method of FIG. 5 is preferably employed in software which needs as input a number of cycles considered a minimum number of cycles that a unit should be shut off before a real power savings is seen.

Referring to FIG. 5, assuming, for example, that the minimum number of cycles that a unit should be shut off before a real power savings is seen is 5-cycles (instructions). An input table 300 is constructed with the same number of rows and columns as table 200 of FIG. 4 with each check mark in FIG. 4 represented by a logical “1” value in input table 300. An output table 301 has the same number of rows and columns as input table 300 and has a value of “1” when the control signals to switches 108 (FIG. 3) for the logic (none or more of groups 101-107) corresponding to that column are to be set to NOT SLEEP (i.e., logic is to be powered). In block 304, the method is initialized and begins with a first row of input table 300.

The method looks ahead a minimum number cycles desired for power savings (in this illustrative case the minimum number of cycles (or instructions) is 5) to see if the unit can be powered off, and if so, sets a corresponding cell in output table 301 to “1”. This is performed by checking each cell in a first row of input table 300, in block 306. The current cell value is represented by “C” and can have the value of “1” or “0”. A previous row value in output table is represented by “P”. It should be noted that a predecessor row of all 1's in output table 301 can be employed for the first row being considered by the method. Now a determination of instruction activity is determined by logically ORing a minimum number of rows corresponding to the minimum number of cycles (e.g., 5). The result of this logical OR operation is represented by N.

In block 308, if C=1, then the program path continues with block 310. Otherwise, the program path continues with block 312. In block 310, the logic device or group corresponding to the cell with C=1 should remain on. Therefore, the corresponding position in output table 301 is set to “1”. In block 312, if the logic unit or group (e.g., one of groups 101-107) will not be used within 5 cycles (C=0, N=0), or will be used within 5 cycles but is already powered off (C=0, P=0) then the logic unit or group corresponding to that cell is to be left off until needed. If these conditions exist, a “0” is placed in the corresponding position in output table 301.

In block 314, a check is made as to whether all rows are finished. If all rows are not finished, the program path goes to the next row in block 316 and returns to block 306. Otherwise, the program path continues with block 318.

In block 318, insertion of the power control instructions LOAD POWER MAP is performed. The number of LOAD POWER MAP (LPM) instructions inserted represents a balance between the power savings of turning off some of the units (e.g., 101-107) and the power and instruction space wasted with the new instructions. In the extreme case, a new power control value could be loaded every cycle, thus doubling the number of instructions. In other cases, the power control instruction may be performed every x cycles. Thus, a maximum number of power control instructions per unit of code is preferably adhered to, the actual value of x can be set by considering the total size of the program with and without the LPM instructions and the total power expended in executing the LPM instructions inserted. Each LPM instruction inserted may degrade program performance since the instruction takes up one execution cycle which could be used for other instructions and may expend power during it fetching and execution. The total of the power expended executing LPM instructions should remain well below the power saved by turning off the virtual Vdd/ground of the units 101-107 (FIG. 3).

Referring to FIG. 6, an example is presented for implementing table 200 of FIG. 4 which has power control instructions added according to output table 301 of FIG. 5. Note that in this example, units are turned off in the cycle in which their output table value goes from 1 to 0. As shown in FIG. 6, an instruction sequence includes a LoadPowerMap (LPM) instruction includes in the instruction an immediate digital data field of, e.g., 1111000, which loads this digital word into power map register 152 (FIG. 3) from output table 301 to enable or disable none, some or all of logic units/groups 101-107. In this example, the digital word 1111000 enables units 101-104 and disables or maintains units 105-107 in an off state. Next, instruction 1 is performed followed by another LPM instruction (0111000), instructions 2 and 3, LPM instruction (0011000) and instructions 4 and 5. Then, the LPM instruction inserted between instruction 5 and 6 turns on an additional unit one cycle early to avoid inserting another power mask instruction on the next cycle. Then, instructions 6, 7, 8 LPM (1000110), 9 and 10 are performed.

Correct operation of programs which actively control power map register 152 with LPM instructions provides that the correct state of the register be maintained across program interrupts. Processing of the state of power map register 152 is preferably integrated with the interrupt handling program. When a program interrupt occurs, usually as the result of an external event, the currently running program with its associated power map register state is halted and the interrupt handling program is invoked. The interrupt handling program first ensures that all the execution resources the program needs are powered by setting a value appropriate to the program's needs into power map register 152. The program delays until the LPM instruction is executed and the state of the execution unit's power corresponds to the state loaded into register 152. This delay is due to normal pipeline delays between fetching an instruction (in this case the LPM) and its execution (i.e., the turning on of any off units which may be needed).

In one embodiment, the state of the power map register 152 of the interrupted program could be saved prior to loading the new value corresponding to the execution resource needs of the interrupt handler program. This would permit the interrupt handler to restore the value to the power map register just prior to the resumption of the interrupted program. This is not required for correct program operation, however.

Alternatively, the interrupted program could be resumed with a value of all “1”s in the power mask register at a slight loss of power savings. The next LPM instruction executed in the resumed program will set the power mask register to the correct value.

The above disclosure of the present invention provides an apparatus and compiler methods with reference to a single issue, in order processor. The compiler described herein assumes instructions executed in conceptual machine order, and the compiler performs its analysis on that basis. However, the present invention is applicable to multi-issue, out of order machines as well. This may be implemented by employing additional hardware for the issue logic of such machines to analyze the mask of the LPM instructions. This logic would be similar to the logic needed to scoreboard register usage and would decrease the power savings accordingly due to the addition of the logic.

Having described preferred embodiments for power control of a processor using hardware structures controlled by a compiler with an accumulated instruction profile (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A microprocessor, comprising:
at least one logic circuit;
a selection device coupled to the at least one logic circuit, the selection device providing switching of on/off states of the at least one logic circuit based on a stored logical value; and
a program instruction which sets the stored logical value to control the on/off states of the at least one logic circuit based on anticipated usage of the at least one logical circuit in accordance with an instruction sequence of the microprocessor.

2. The microprocessor as recited in claim 1, wherein the selection device includes a switch which provides a connection from a supply voltage to a power line of the at least one logic circuit in an on state.

3. The microprocessor as recited in claim 1, wherein the selection device includes a switch which provides a connection from ground to a power line of the at least one logic circuit in an on state.

4. The microprocessor as recited in claim 1, further comprising a register coupled to the selection device to store the stored logic value.

5. The microprocessor as recited in claim 4, wherein the register is updated after a number of instruction cycles.

6. The microprocessor as recited in claim 1, further comprising an input table including an instruction sequence and associated resource needs for the at least one logical unit wherein the anticipated usage is determined in accordance with the input table.

7. The microprocessor as recited in claim 1, wherein the anticipated usage of the at least one logical unit includes usage of the at least one logical device after a number of instruction cycles.

8. The microprocessor as recited in claim 1, further comprising an output table including logical states corresponding to power-saving on/off states of the at least one logical device and the program instruction sets the stored logical value to control the at least one logic circuit in accordance with the power-saving on/off states.

9. A microprocessor, comprising:
a plurality of logic circuits divided into functional groups;
a selection device coupled to each of the functional groups, each selection device providing switching of on/off states of the corresponding functional group based on logical values stored in a register;
a program instruction which sets the logical values in the register to control the on/off states of the functional groups; and
a compiler program which generates the logical values to be set in the register based on instruction sequences which anticipate usage of each of the functional groups.

10. The microprocessor as recited in claim 9, wherein the selection devices each include a switch which provides a connection from a supply voltage to a power line of the functional group in an on state.

11. The microprocessor as recited in claim 9, wherein the selection devices each include a switch which provides a connection from ground to a power line of the functional group in an on state.

12. The microprocessor as recited in claim 9, wherein the register includes one memory location for each functional group.

13. The microprocessor as recited in claim 9, wherein the register is updated after a number of instruction cycles.

14. The microprocessor as recited in claim 9, further comprising an input table generated by the compiler program and including an instruction sequence and associated resource needs for the each of the functional groups wherein the usage of the functional groups is determined in accordance with the input table.

15. The microprocessor as recited in claim 9, wherein the usage of the functional groups includes usage of the functional groups after a number of instruction cycles.

16. The microprocessor as recited in claim 9, further comprising an output table including logical states corresponding to power-saving on/off states of the functional groups.

17. A method for generating embedded instruction sequences to control power to logic circuits in a microprocessor, comprising the steps of:
generating an instruction sequence which controls a functional program for the microprocessor;
analyzing the instruction sequence to determine which of the logic circuits are active on each instruction cycle; comparing a number of instruction cycles for which each logic circuit will be inactive after a current instruction cycle to a value for each instruction cycle of the functional program; and
inserting instruction sequences to turn each of the logical circuits on or off based on the comparing step.

18. The method as recited in claim 17, wherein the step of inserting instruction sequences include programming a register with logical values wherein each of the logical circuits are turned on or off based on the logical values.

19. The method as recited in claim 17, wherein the value of the comparing step includes a number determined to provide net power savings in the logical circuits.

20. A program storage device readable by machine, tangibly embodying a program of instructions executable by the machine to perform method steps as recited in claim 17.
